(19) United States
(12) Patent Application Publication
(10) Pub. No.: US 2014/0035830 A1
(43) Pub. Date: Feb. 6, 2014

(54) DEVICE AND METHOD FOR TOUCH SENSOR ELIMINATING SHADOWING

(71) Applicants: Yi Wei, St. James, NY (US); Amit Pai, Farmingville, NY (US); Aroon Tungare, Winfield, IL (US); Ron Zancola, West Sayville, NY (US)

(72) Inventors: Yi Wei, St. James, NY (US); Amit Pai, Farmingville, NY (US); Aroon Tungare, Winfield, IL (US); Ron Zancola, West Sayville, NY (US)

(73) Assignee: Motorola Solutions, Inc., Schaumburg, IL (US)

(21) Appl. No.: 13/563,040

(22) Filed: Jul. 31, 2012

(51) Int. Cl. G06F 3/041; G09G 5/02

(52) U.S. Cl. 345/173

(57) ABSTRACT

A device and method eliminates a shadowing effect on a touch input receiving device. The method includes receiving a touch input on a top layer that includes first conducting lines, a first current passing through the first conducting lines. The method includes determining a location of the touch input as a function of the first current passing through an intermediate layer as a second current to second conducting lines orthogonal to the first conducting lines of a bottom layer. The intermediate layer disposed between the top and bottom sides is configured as a resistive layer applying a resistance value to the first current upon the touch input being received. The first current continues through the first conducting lines along a remainder thereof as a third current after passing through the intermediate layer to eliminate the shadowing effect.

### FIELD OF THE DISCLOSURE

The present disclosure relates generally to a device and method of a touch sensor and more particularly to eliminating shadowing for the touch sensor that incorporates a pressure measurement.

### BACKGROUND

An electronic device may incorporate a variety of different input technologies. For example, the electronic device may include a keypad to allow a user to enter inputs. In another example, the electronic device may include a touch sensor that enables a user to enter inputs. Conventional touch technologies include many different types, each with its own set of advantages and disadvantages. A fundamental reason for the different types of touch technologies is that different interpretation methods are used to detect touch inputs. For example, capacitive touch screens interpret a human touch as a change in capacitance measured by the touch panel and resistive touch screens interpret a human touch as a change in resistance measured by the touch panel.

An input entered through a touch screen consists of three degrees of freedom: position, time, and force. However, conventional touch screens sense only two of the three possible degrees of freedom of touch input, namely position and time. Much of the information in the third dimension of force is not captured during touch detection. This partial recognition of user input results in less intuitive interpretations and more cumbersome touch inputs.

FIG. 1 shows a conventional touch sensor 100 as is known in the art. The conventional touch sensor 100 may be, for example, a multi-touch digital matrix resistive (DMR) touch panel. Accordingly, the conventional touch sensor 100 may include a top electrode layer 105 separated from a bottom electrode layer 110 by at least one spacer dot 115. The top electrode layer 105 may include conducting lines 120 disposed on a bottom layer thereof that are orthogonal to conducting lines 125 disposed on a top layer of the bottom electrode layer 110. The cross points of the conducting lines of the top and bottom electrode layers (which overlap but do not intersect) form switches that can be turned on or off. For the DMR touch panel, when a touch is performed, an electrical short at the touch point is generated and the resistance changes from a very high value to zero.

FIG. 2 shows the conventional touch sensor 100 when a touch input is received thereon as is known in the art. As illustrated, a first touch input 130 may be received on the touch sensor 100. Accordingly, the short circuit generated results in the conducting line 120 contacting the conducting line 125 for the current to flow therethrough. However, when a second touch input is registered on the same conductive line (e.g., conducting line 120), the touch input 130 may generate a shadowing effect for a second touch input 135. That is, the ensuing shadowing effect (especially when a large touch input such as a palm) forces the second touch input 125 in the shadow to not be detected. Accordingly, the shadowing effect hinders the multi-touch operation. For example, during signature signing, in some writing position (e.g., when a palm presses on the touch panel), the signature written using a stylus is not captured due to the shadowing effect caused by the palm.

FIG. 3 shows the shadowing effect on the conventional touch sensor 100 as is known in the art. FIG. 3 illustrates how a touch spot 140 in which the touch input is received on the conventional DMR touch sensor 100 generates the shadowing effect. Specifically, the drawn traces 145 become broken so that if the touch spot 140 represents the first touch input 130, the second touch input 135 received in the shadow on the conventional DMR touch sensor 100 is not detected. FIG. 4 shows a schematic of the conventional DMR touch sensor 100 when a shadowing effect is experienced as is known in the art. As discussed above, the DMR touch panel may include on/off switches at the cross points of the top and bottom conducting lines. The current I₀ may pass through the conducting lines so that when the touch input 130 is received on the touch spot 140 at the cross points 150, the electrical shorts 155 are created in which the current I₀ is redirected. However, the first touch input 130 may generate a shadow 160 as shown by the area formed by the broken lines 145 in FIG. 3. That is, the current I₀ no longer passes through the conducting lines for a further short to be created from the second touch input 135 in the shadow area 160.

Accordingly, there is a need for a touch sensor that eliminates the shadowing effect when the touch sensor is configured to receive multiple touch inputs, including the force parameter.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a conventional Digital Matrix Resistive (DMR) touch sensor as is known in the art.

FIG. 2 is the conventional touch sensor of FIG. 1 with a first touch input and a second touch input being received thereon as is known in the art.

FIG. 3 shows the shadowing effect from the first touch input on the conventional DMR touch sensor of FIG. 1 as is known in the art.

FIG. 4 is a schematic illustrating the shadowing effect on the conventional touch sensor of FIG. 1 when receiving the first touch input as is known in the art.

FIG. 5 is a touch sensor in accordance with some embodiments of the present invention.

FIG. 6 is an electronic device including the touch sensor of FIG. 5 in accordance with some embodiments.

FIG. 7 is a further view of the touch sensor of FIG. 5 in accordance with some embodiments.

FIG. 8 is the touch sensor of FIG. 5 with a touch input received thereon in accordance with some embodiments.

FIG. 9 is a schematic of the touch sensor of FIG. 5 when receiving the touch input in accordance with some embodiments.

FIG. 10 is a method of eliminating a shadowing effect in accordance with some embodiments.

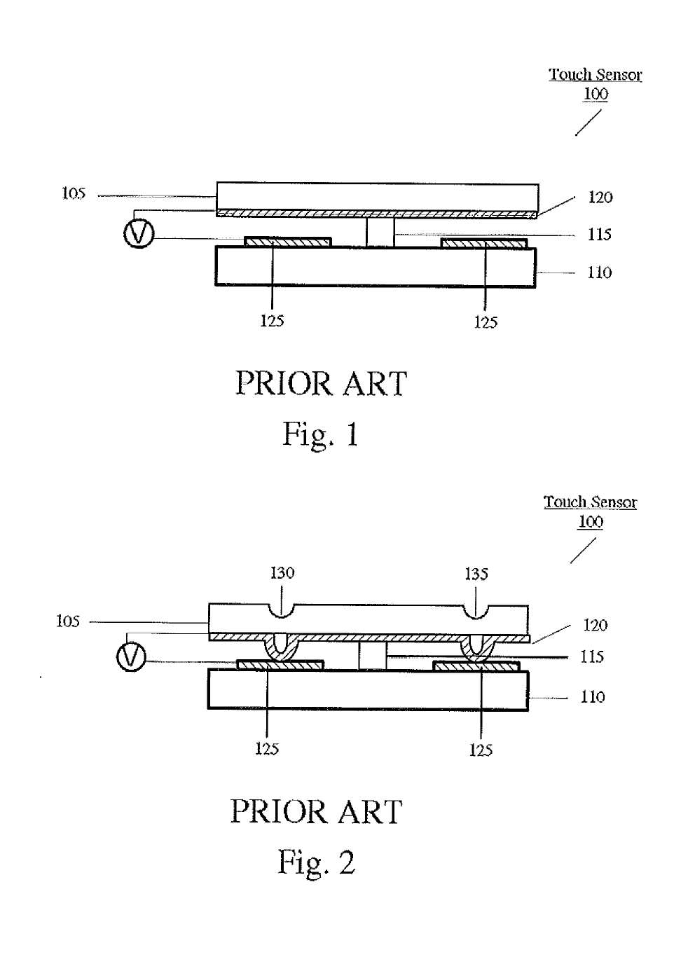

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A device and method of the present invention relates to eliminating a shadowing effect on a touch input receiving device. The method comprises receiving a touch input on a top side of a top layer of a touch input receiving device, the top layer including a first plurality of conducting lines on a bottom side of the top layer, a first current having a first value passing through the first plurality of conducting lines; and determining a location of the touch input on the touch input receiving device as a function of the first current passing through an intermediate layer of the touch input receiving device as a second current having a second value to a second plurality of conducting lines orthogonal to the first plurality of conducting lines on a top side of a bottom layer of the touch input receiving device, wherein the intermediate layer has a top side and a bottom side, the top side of the intermediate layer disposed adjacent the bottom side of the top layer and the bottom side of the intermediate layer disposed adjacent the top side of the bottom layer, the intermediate layer configured as a resistive layer applying a resistance value to the first current upon the touch input being received, wherein the first current continues through the first conducting lines along a remainder thereof as a third current having a third value after passing through the intermediate layer to eliminate the shadowing effect by enabling a further touch input to be received on the top side of the top layer along the remainder of the first conducting lines.

The exemplary embodiments may be further understood with reference to the following description and the appended drawings, wherein like elements are referred to with the same reference numerals. The exemplary embodiments describe a device and method for a touch sensor configured to detect multiple degrees of freedom in a touch input. Specifically, the touch screen is configured to determine a position, a time, and a force of the touch input on the touch screen. As will be described in further detail below, the touch screen is further configured to eliminate a shadowing effect associated with a touch input including the force parameter of the touch input. The touch screen, the components thereof, the degrees of freedom, the shadowing effect, the elimination thereof, and a related method will be discussed in further detail below.

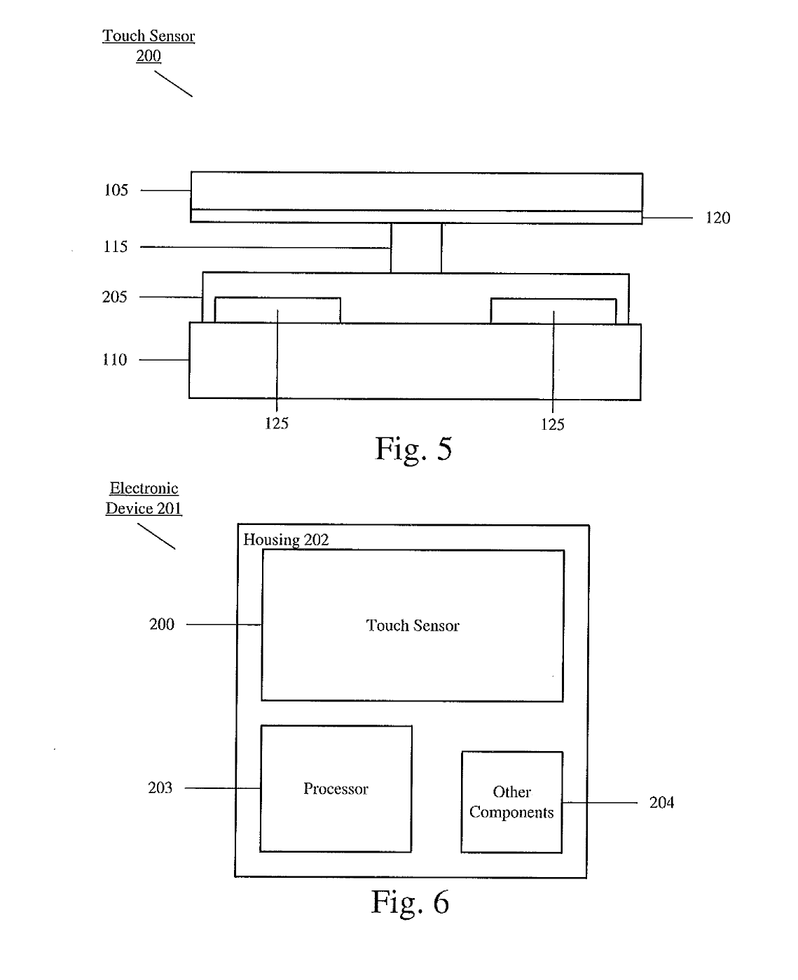

FIG. 5 is a touch sensor 200 in accordance with an exemplary embodiment of the present invention. FIG. 6 is an electronic device 201 that includes the touch sensor 200 in accordance with an exemplary embodiment of the present invention. The electronic device 201 may include a housing 202, a processor 203, and other components 204 such as a memory, a transceiver, etc. The touch sensor 200 may be utilized with any electronic device 201 that is configured to receive inputs and/or outputs. The electronic device 201 may be any type such as a desktop computer, a laptop, a cellular phone, a personal digital assistant, a tablet, etc. The touch sensor 200 may further provide additional functionalities such as being adapted for a display of the electronic device 201, thereby showing data to a user. As will be discussed in further detail below, the touch screen 200 according to the exemplary embodiments enable position data, time data, and force data to be measured for each touch input that is applied on the touch sensor 200. Specifically, the touch sensor 200 detects touch by measuring a local pressure exerted on the touch screen 200 at a particular position during a specified time or time duration. Since a user feels touch by the pressure felt by a finger tip used for the touch action, there is no interpretation involved. That is, what the user feels is what the touch sensor 200 measures, thereby eliminating virtually all limitations of conventional touch screen limitations. The touch sensor 200 may include the top layer 105 including the conducting lines 120 disposed on a bottom surface thereof, a bottom layer 110 including conducting lines 125 orthogonal to the conducting lines 120 and disposed on a top surface thereof, an intermediate layer 205 disposed on the top surface of the bottom layer 110 and over the conducting lines 125, and at least one spacer dot 115 separating the top layer 105 from the bottom layer 110.

In a specific exemplary embodiment of the present invention, the top layer 105 may include a transparent conducting layer/traces such as indium tin oxide (ITO) and a flexible transparent material such as polyethylene terephthalate layer (PET) while the bottom layer 110 may include a transparent conducting layer/traces such as ITO. However, it should be noted that the use of ITO and PET as described in the present application is exemplary only. The bottom ITO, the top ITO, and the PET may represent any substantially similar layers that are capable of performing the functions of the ITO and the PET. Thus, the ITO may represent any transparent conducting layer or conducting trace while the PET may represent any flexible transparent material. It should also be noted that the ITO may also be made with a non-transparent material such as a metal trace but in a thin enough width (e.g., 5 microns or less) so that it is nearly invisible.

The intermediate layer 205 may be any resistive layer that provides a finite resistance for the current flowing through the conducting lines 120, 125 when a touch input is received. According to a first exemplary embodiment of the present invention, the intermediate layer 205 may be a force sensing layer that is transparent or non-transparent based upon the application or use related to the touch sensor 200. Thus, in a specific exemplary embodiment, the intermediate layer 205 may consist of a transparent conducting oxide (TCO) nano particles dispersed in a transparent polymer matrix. As a result, the TFS 215 is configured so that the resistance thereof becomes highly sensitive to pressure near the composition of a percolation threshold. According to a second exemplary embodiment, the intermediate layer 205 may be a piezo-resistive layer. Thus, the piezo-resistive layer may provide a piezoresistive effect when a mechanical stress is applied on the top layer 105 for a touch input that is received. It should be noted that the intermediate layer 205 may represent any resistive layer that provides a resistance to the current flowing through the conducting lines 120, 125. For example, [can you please provide other examples of a resistive layer?]. It should also be noted that the intermediate layer 205 may be a variable resistive layer. That is, as a function of the pressure being applied on the top side of the top layer 105 from the touch input, the resistance value applied to a current passing therethrough may change as a function of the pressure value.

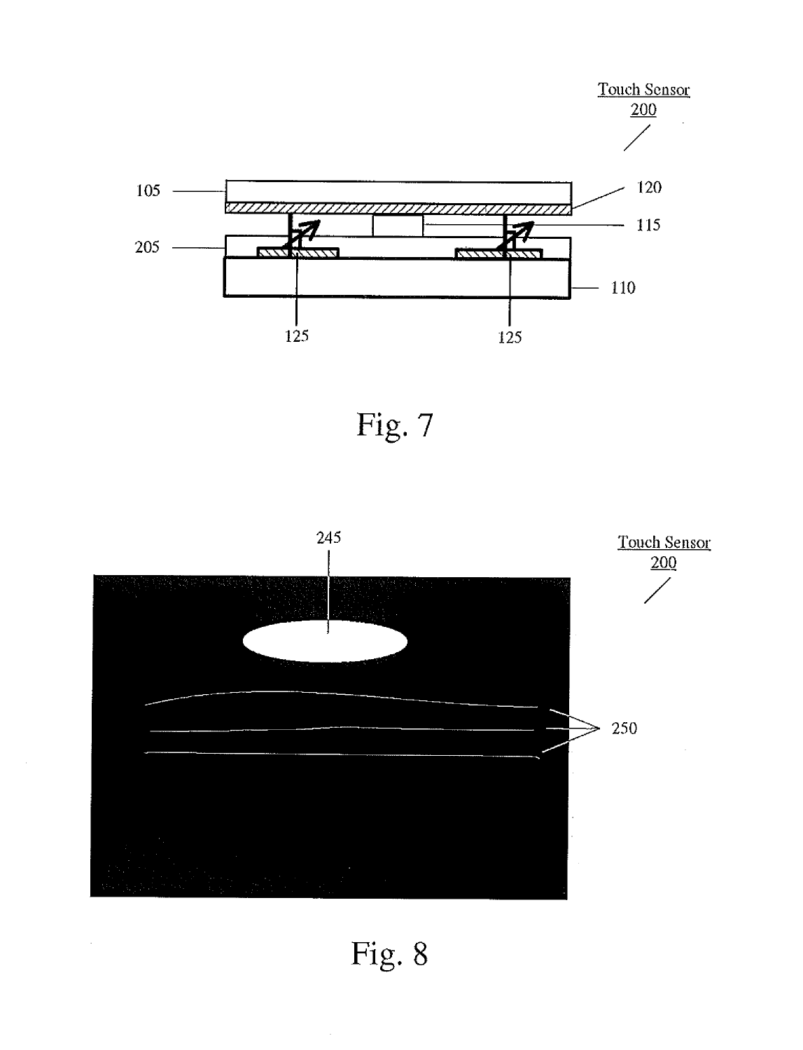

FIG. 7 is a further view of the touch sensor 200 of FIG. 5 in accordance with some embodiments. According to a preferred exemplary embodiment, as illustrated in FIG. 7, the intermediate layer 205 may include attenuators to reduce an amplitude or power of a signal without appreciably distorting its waveform, for example, by providing a loss or a gain less than 1. As will be described in further detail below, the inclusion of the attenuators in the intermediate layer 205 provides the feature of eliminating the shadowing effect for the touch sensor 200 that receives the force parameter. Accordingly, the intermediate layer 205 provides a highly resistive force sensing layer. Furthermore, the on/off switches of a conventional DMR touch panel are effectively replaced so that the shadowing effect is not produced. It should be noted that the use of attenuators is only exemplary. According to another exemplary embodiment of the present invention, the intermediate layer 205 may include any resistor that includes the appropriate functionalities to provide the highly resistive force sensing layer.

According to the exemplary embodiments of the present invention, the pressure on the touch sensor 200 is measured by the resistance change upon applied pressure on the top layer 105. Utilizing a hybrid operating mode for more than one touch input (e.g., light touches and hard presses), the resistance of each individual pixel first decreases from the contact area increasing, which is a result from the applied pressure of the touch action. The intermediate layer 205 is configured to be very sensitive to small forces that may be indicative of light touches. Furthermore, with at least one of the layers of the touch sensor 200 being pixilated, the contact area may quickly saturate under a small amount of pressure. Accordingly, a further part of the percolation measurement is present. Specifically, as the resistance of the intermediate layer 205 is highly sensitive to pressure near the composition of the percolation threshold, applied pressure leads to small deformations, thereby resulting in a resistivity decrease. This mode of operation is more sensitive in the higher force range when the contact area is saturated. However, the polymer matrix deformation has only started. Thus, depending on, for example, a Young's modulus of the polymer matrix, the polymer of the intermediate layer 205 may be adjusted so that the contact mode (i.e., for light touch) and the percolation mode (i.e., for hard press) make a smooth transition.

The processor 203 may be configured to receive a current from the conducting lines 120, 125. The processor 203 may further be configured to determine when a touch input is received from the values of the current flowing through the conducting lines 120, 125. When no touch input is received, a first current having a first value may continuously flow through the conducting lines 120. The first current having the first value may be indicative of no touch input being received, thereby the processor 203 interpreting this as no touch input. When a touch input is received, the intermediate layer 205 provides a finite resistance that alters the current flowing through the conducting lines 120, 125. Accordingly, when a touch input is received, a short circuit is generated at the cross points of the conducting lines 120, 125. The current flowing through the intermediate layer 205 generates a second current having a second value flowing through a remainder of the conducting lines 120. Furthermore, the current flows through the short circuit. Thus, the current flowing through the intermediate layer 205 generates a third current having a third value flowing through the conducting lines 125 at the cross points of the touch input. The processor 203 may receive the third current having the third value from the conducting lines 125 to indicate that the touch input is received at those cross points. The second current having the second value flowing through the remainder of the conducting lines 120 allows for the shadowing effect to be eliminated as a further touch input may be received on the conducting lines 120 to generate a further short circuit.

Thus, in an exemplary embodiment in which a further touch input is received, the second current having the second value flowing through the remainder of the conducting lines 120 may allow for the further touch input to be received which would otherwise be located in an area of the touch sensor 200 having a conventional shadowing effect. When the further touch input is received on an area of the remainder of the conducting lines 120 which received the first touch input, the second current having the second value flows through the intermediate layer 205 at the cross points of the further touch input. Subsequently, the second current having the second value continues through a further remainder of the conducting lines 120 as a fourth current having a fourth value. The short circuit generated by the further touch input allows for the second current having the second value to flow through the intermediate value so that a fifth current having a fifth value to flow through the conducting lines 125. The processor 203 may receive the fifth current having the fifth value to determine that the further touch input is received.

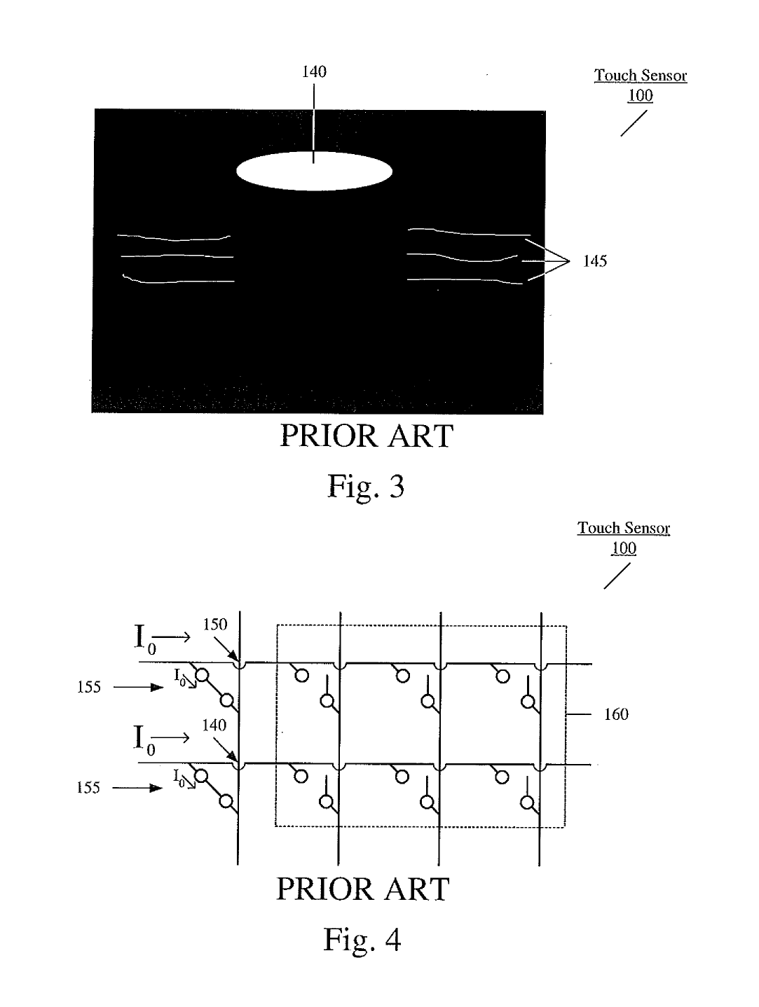

FIG. 8 is the touch sensor 200 of FIG. 5 with a touch input received thereon in accordance with some embodiments. As illustrated in FIG. 8 and in contrast to the conventional touch sensor 100 of FIG. 3, a touch spot 245 received thereon does not generate the shadowing effect. Specifically, the conducting lines 250 include no breaks so that if the touch spot 245 represents a first touch input, a second touch input may be received and detected as no shadow is present.

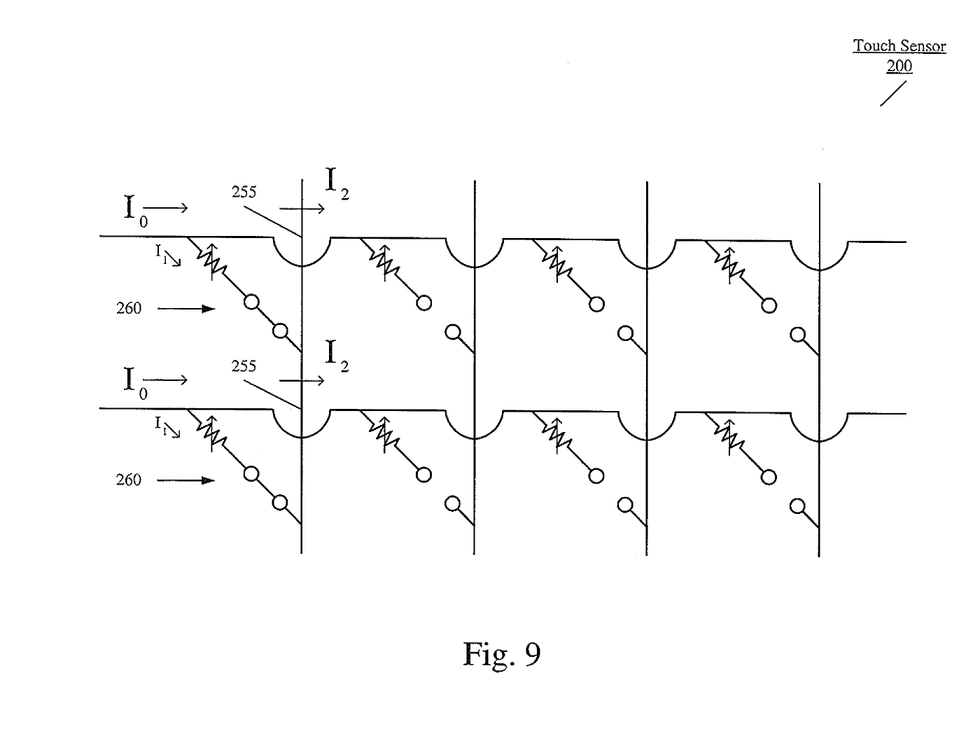

FIG. 9 is a schematic of the touch sensor 200 of FIG. 5 when receiving the touch input in accordance with some embodiments. In contrast to the schematic illustrated in FIG. 4 for the conventional touch sensor 100, the schematic of FIG. 9 according to the exemplary embodiments of the present invention do not have a shadowing effect. As discussed above, the intermediate layer 205 may be a highly resistive force sensing layer providing a finite resistance to the current flowing through the conducting lines 120 so that the shadowing effect is eliminated. For example, if the top layer 105 includes the conducting lines 120 while the bottom layer 110 includes the conducting lines shown 125 which are orthogonal to the conducting lines 120, the current I₀ may pass through the conducting lines 120 of the top layer 105. A touch input may be received on the touch spot 245 at the cross points 255. The electrical shorts 260 may result from the touch input. However, since the intermediate layer 205 utilizes the attenuators, the short circuit may generate a current I₁ passing therethrough. The current I₁ may further pass through the conducting lines 125. Furthermore, as there is no shadow created due to the intermediate layer 205, a current I₂ may continue to pass through the remainder of the touch sensor 200, in particular, through the conducting lines 120. Accordingly, further touch inputs may be received at any other area of the touch sensor 200 not occupied by a prior touch input.

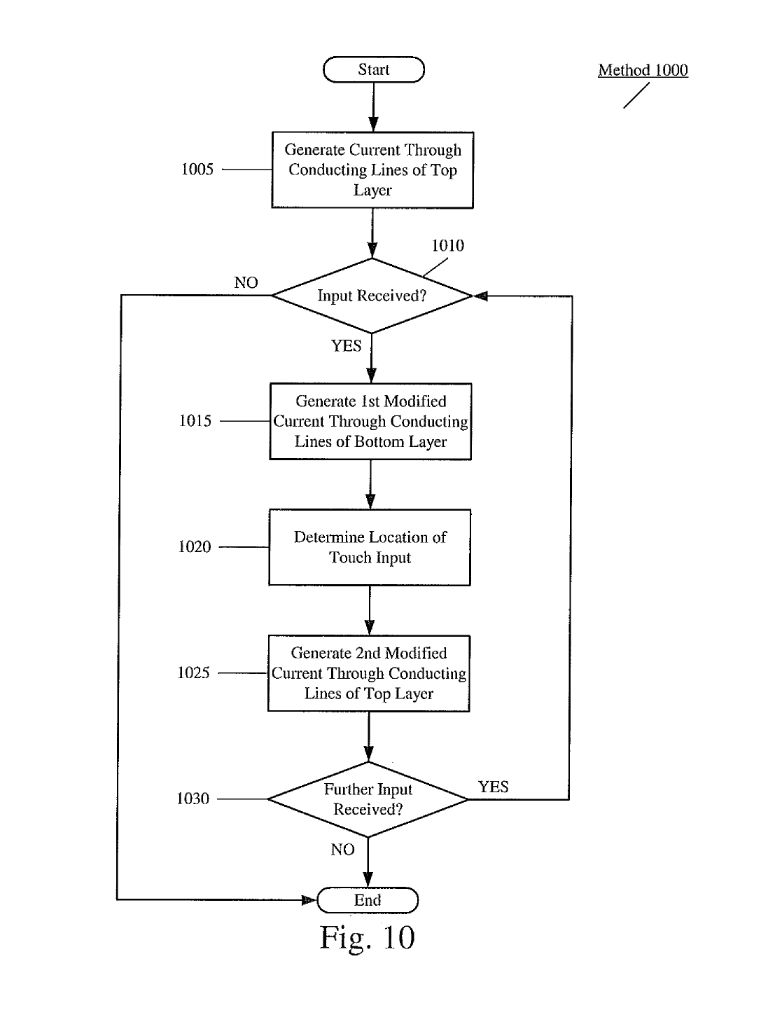

FIG. 10 is a method 1000 of eliminating a shadowing effect in accordance with some embodiments. The method 1000 relates to receiving a touch input and eliminating the shadowing effect so that a further touch input is capable of being received on the touch sensor. The method 1000 will be described with reference to the touch sensor 200.

In step 1005, a current is generated through the conducting lines 120 of the top layer 105. As described above, a bottom surface of the top layer 105 may include a first set of conducting lines 120. The conducting lines 120 may be configured so that the current flows therethrough.

In step 1010, the processor 203 determines if a touch input is received on a top surface of the top layer 105. When the current remains constant through the conducting lines 120, the processor 203 may determine that no touch input is received. Furthermore, the processor 203 may not receive a current value from the conducting lines 125 since no short circuit is created between the conducting lines 120, 125. However, according to the exemplary embodiments, when the touch input is received, the current flowing through the conducting lines 120 may change from flowing through the intermediate layer 205 and the conducting lines 125 may include a current flowing therethrough at the cross points of the conducting lines 120, 125 at the location where the touch input is received. Thus, when the touch input is received, the method 1000 continues to step 1015.

In step 1015, a first modified current is generated through the conducting lines 125 of the bottom layer 110. As discussed above, the short circuit between the conducting lines 120, 125 allows for the current passing through the conducting lines 120 to flow through the conducting lines 125. As the current passes through the intermediate layer 205, the current flowing through the intermediate layer 205 generates the first modified current. Accordingly, in step 1020, the processor 203 is configured to determine the location of the touch input.

In step 1025, as a further consequence of the short circuit created from the touch input, a second modified current is generated through the conducting lines 120 of the top layer 105. Specifically, the current passing through the conducting lines 120 of the top layer 105 in step 1005 passes through the intermediate layer 205. Consequently, the current flowing through the intermediate layer 205 further generates the second modified current. The second modified current enables the shadowing effect to be eliminated as a further touch input may be received on the remainder of the conducting lines 120.

It should be noted that upon the current being generated through the conducting lines 120 of the top layer 105 in step 1005 may result in steps 1015 and 1025 in which the first and second modified currents are generated. That is, the first and second modified currents may automatically be generated as a result of the short circuit from the touch input being received in step 1010. Furthermore, it should be noted that upon the touch input being completed (e.g., finger raised off the top surface of the top layer 105), the current generated in step 1005 may again resume flowing through the conducting lines 120. As the current is no longer being passed through the intermediate layer 205, the current is not modified.

In step 1030, the processor 203 determines if a further touch input is received. When a further touch input is received, the method 1000 returns to step 1010. As discussed above, the first touch input being received results in various currents passing through the conducting lines 120, 125. Thus, the first touch input includes a first current having a first value originally passing through the conducting lines 120. When the first touch input is received, the first current having the first value is altered from passing through the intermediate layer 205. Accordingly, a second current having a second value passes through the conducting lines 125 of the bottom layer 110 (from the short circuit) while a third current having a third value passes through the remainder of the conducting lines 120 of the top layer 105. When a second touch input is received on the remainder of the conducting lines 120 of the top layer 105, the third current having the third value is altered again from passing through the intermediate layer 205. Accordingly, a fourth current having a fourth value passes through the conducting lines 125 of the bottom layer 110, thereby the processor 205 being configured to determine the location of the second touch input (step 1020 upon second run of the steps 1010-1030). A fifth current having a fifth value passes through a further remainder of the conducting lines 120 of the top layer 105. Thus, the shadowing effect is continuously eliminated as any number of touch inputs are capable of being received on the remainder of the conducting lines 120.

The exemplary embodiments of the present invention provide a touch sensor that is configured for determining all three degrees of freedom of a touch input and eliminate a shadowing effect. In particular, the touch sensor is capable of determining a pressure of the touch input and maintain the capability of receiving a further touch input at all other areas of the touch sensor. An intermediate layer may be disposed between a top layer and a bottom layer that provides a finite resistance to conducting lines of the top and bottom layer. Specifically, the intermediate layer may provide a highly resistive force sensing layer so that a conventional on/off switch configuration of the touch sensor is no longer utilized which otherwise creates the shadow from a touch input including a force parameter.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for eliminating a shadowing effect, comprising:
receiving a touch input on a top side of a top layer of a touch input receiving device, the top layer including a first plurality of conducting lines on a bottom side of the top layer, a first current having a first value passing through the first plurality of conducting lines; and
determining a location of the touch input on the touch input receiving device as a function of the first current passing through the first plurality of conducting lines and a second plurality of conducting lines orthogonal to the first plurality of conducting lines on a top side of a bottom layer of the touch input receiving device,
wherein the first current passes through an intermediate layer of the touch input receiving device as a second current having a second value at a cross point of the first conducting lines and the second conducting lines, wherein the cross point corresponds to the location where the touch input is received, and wherein intermediate layer has a top side and a bottom side, the top side of the intermediate layer disposed adjacent the bottom side of the top layer and the bottom side of the intermediate layer disposed adjacent the top side of the bottom layer, the intermediate layer configured as a resistive layer applying a resistance value to the first current upon the touch input being received, and
wherein after passing through the intermediate layer, the first current continues through remainder of the first conducting lines as a third current having a third value that enables further touch input to be received on the top side of the top layer thus eliminating the shadowing effect.

2. The method of claim 1, wherein the top layer includes a transparent conducting layer and a flexible transparent material.

3. The method of claim 1, wherein the intermediate layer is a transparent, variable resistance layer configured to change the resistance value as a function of a pressure value associated with the touch input.

4. The method of claim 1, wherein the intermediate layer is a non-transparent, variable resistance layer configured to change the resistance value as a function of a pressure value associated with the touch input.

5. The method of claim 1, wherein the touch input generates a short circuit at the cross point of the first and second conducting lines so that the first current passes from the first conducting lines to the second conducting lines as the third current.

6. The method of claim 5, wherein the intermediate layer generates a resistor at the cross point of the first and second conducting lines corresponding to the location where the touch input is received.

7. The method of claim 1, further comprising:
receiving the further touch input on the top side of the top layer along the remainder of the first conducting lines; and
determining a further location of the further touch input on the touch input receiving device as a function of the third current passing through the intermediate layer as a fourth current having a fourth value to the second plurality of conducting lines,
wherein the third current continues through the first conducting lines as a fifth current having a fifth value after passing through the intermediate layer.

8. The method of claim 1, wherein the bottom side of the intermediate layer is disposed on the top side of the bottom layer over the second plurality of conducting lines.

9. The method of claim 8, wherein the top side of the intermediate layer is disposed separate from the bottom side of the top layer by at least one spacer dot.

10. The method of claim 1, wherein the first current, the second current, and the third current are indicative of at least one of position data, time data, and pressure data of the touch input.

11. A touch input receiving device configured to eliminate a shadowing effect, comprising:
a top layer having a top side and a bottom side, the top side of the top layer configured to receive a touch input, the top layer including a first plurality of conducting lines on the bottom side of the top layer;
an intermediate layer having a top side and a bottom side, the top side of the intermediate layer disposed adjacent the bottom side of the top layer, the intermediate layer configured as a resistive layer applying a resistance value to a first current having a first value passing through the first conducting lines upon the touch input being received; and
a bottom layer having a top side and a bottom side, the top side of the bottom layer disposed adjacent the bottom side of the intermediate layer, the top side of the bottom layer including a second plurality of conducting lines orthogonal to the conducting lines of the top layer,
wherein the first current passes through the intermediate layer as a second current having a second value at a cross point of the first conducting lines and the second conducting lines to indicate the touch input being received on the top side of the top layer, and the first current, after passing through the intermediate layer, continues through remainder of the first conducting lines as a third current having a third value that enables further touch input to be received on the top side of the top layer thus eliminating the shadowing effect.

12. The touch input receiving device of claim 11, wherein the top layer includes a transparent conducting layer and a flexible transparent material.

13. The touch input receiving device of claim 11, wherein the intermediate layer is a transparent, variable resistance layer configured to change the resistance value as a function of a pressure value associated with the touch input.

14. The touch input receiving device of claim 11, wherein the intermediate layer is a non-transparent, variable resistance layer configured to change the resistance value as a function of a pressure value associated with the touch input.

15. The touch input receiving device of claim 11, wherein the touch input generates a short circuit at the cross point of the first and second conducting lines so that the first current passes from the first conducting lines to the second conducting lines as the third current.

16. The touch input receiving device of claim 15, wherein the intermediate layer generates a resistor at the cross point of the first and second conducting lines corresponding to the location where the touch input is received.

17. The touch input receiving device of claim 11, wherein the further touch input includes the third current passing through the second conducting lines after passing through the intermediate layer as a fourth current having a fourth value to indicate the further touch input being received on the top side of the top layer, the third current continuing through the first conducting lines as a fifth current having a fifth value after passing through the intermediate layer.

18. The touch input receiving device of claim 11, wherein the bottom side of the intermediate layer is disposed on the top side of the bottom layer over the second plurality of conducting lines.

19. The touch input receiving device of claim 18, wherein the top side of the intermediate layer is disposed separate from the bottom side of the top layer by at least one spacer dot.

20. A computer readable storage medium including a set of instructions executable by a processor, the set of instructions operable to:
receive a touch input on a top side of a top layer of a touch input receiving device, the top layer including a first plurality of conducting lines on a bottom side of the top layer, a first current having a first value passing through the first plurality of conducting lines; and
determine a location of the touch input on the touch input receiving device as a function of the first current passing through the first plurality of conducting lines and a second plurality of conducting lines orthogonal to the first plurality of conducting lines on a top side of a bottom layer of the touch input receiving device,
wherein the first current passes through an intermediate layer of the touch input receiving device as a second current having a second value at a cross point of the first conducting lines and the second conducting lines, wherein the cross point corresponds to the location where the touch input is received, and wherein the intermediate layer has a top side and a bottom side, the top side of the intermediate layer disposed adjacent the bottom side of the top layer and the bottom side of the intermediate layer disposed adjacent the top side of the bottom layer, the intermediate layer configured as a resistive layer applying a resistance value to the first current upon the touch input being received, and
wherein, after passing through the intermediate layer, the first current continues through remainder of the first conducting lines as a third current having a third value that enables further touch input to be received on the top side of the top layer thus eliminating a shadowing effect.
